(19) United States
(12) Patent Application Publication
(10) Pub. No.: US 2010/0273421 A1
(43) Pub. Date: Oct. 28, 2010

(54) ELECTRICAL ACCESSORY CONFIGURED TO TRANSMIT ELECTRICAL SIGNALS BETWEEN A FIRST ELECTRICAL DEVICE, A SECOND ELECTRICAL DEVICE AND A THIRD ELECTRICAL DEVICE AND A METHOD OF PROVIDING AND USING THE ELECTRICAL ACCESSORY

(75) Inventors: Jason TU, Mission Viejo, CA (US); Wei Jiang, Torrance, CA (US); David A. Kleeman, Marina del Rey, CA (US); Chad DeJong, Los Angeles, CA (US); Vannin Gale, Anaheim Hills, CA (US); Timothy Brewer, San Diego, CA (US); Richard James Elgie, Irvine, CA (US); Kelly Ferdman, Los Angeles, CA (US); Oliver Duncan Seil, Pasadena, CA (US); Mitchell Suckle, Long Beach, CA (US)

Correspondence Address: BRYAN CAVE LLP, TWO NORTH CENTRAL AVENUE, SUITE 2200, PHOENIX, AZ, 85004, US

(73) Assignee: Belkin International, Inc., Playa Vista, CA (US)

(21) Appl. No.: 12/749,463

(22) Filed: Mar. 29, 2010

Related U.S. Application Data
(63) Continuation-in-part of application No. 12/349,505, filed on Jan. 6, 2009.
Application No. 12/349,505 is a continuation-in-part of application No. 11/248,762, filed on Oct. 11, 2005, now Pat. No. 7,734,256.
Application No. 11/248,762 is a continuation-in-part of application No. 11/842,921, filed on Aug. 21, 2007.
Application No. 11/842,921 is a continuation of application No. 10/936,356, filed on Sep. 8, 2004, now Pat. No. 7,292,881.
(60) Provisional application No. 61/292,477, filed on Jan. 5, 2010.
(60) Provisional application No. 61/310,674, filed on Mar. 4, 2010.

(51) Int. Cl. H04W 88/02; H04B 7/00

(52) U.S. Cl. 455/41.2; 455/73

(57) ABSTRACT

In some embodiments, an electrical accessory can be configured to transmit one or more first data signals to a receiving device. The electrical accessory can include: (a) a first electrical interface configured to mechanically and electrically couple to a first connector of a first electrical device, the first electrical interface further configured to receive a first part of the one or more first data signals from the first electrical device; (b) a first transmitter configured to transmit one or more second data signals to a second electrical device; (c) a first receiver configured to receive a second part of the one or more first data signals from the second electrical device; (d) a second transmitter electrically coupled to the first electrical interface and the first receiver, the second transmitter configured to transmit the one or more first data signals to the receiving device; (e) a first microphone electrically coupled to the first transmitter and configured to receive sounds and convert the sounds into the one or more second data signals; and (f) a controller electrically coupled to the first transmitter, the first receiver, the second transmitter, and the first microphone. The controller can be configured such that the controller instructs the first electrical device to stop providing the first part of the one or more first data signals before or when the first receiver receives the second part of the one or more first data signals from the second electrical device. Other embodiments are disclosed.

### CROSS-REFERENCE TO RELATED APPLICATIONS

This application claims the benefit of U.S. Provisional Application No. 61/292,477, filed Jan. 5, 2010 and U.S. Patent Application No. 61/310,674, filed on Mar. 4, 2010. This application is a continuation-in-part application of U.S. application Ser. No. 12/349,505, filed Jan. 6, 2009 and U.S. patent application Ser. No. 11/248,762, filed Oct. 11, 2005. This application is also a continuation-in-part application of U.S. patent application Ser. No. 11/842,921, filed Aug. 21, 2007, which is a continuation application of U.S. Pat. No. 7,292,881, filed Sep. 8, 2004. U.S. Pat. No. 7,292,881, U.S. patent application Ser. Nos. 12/349,505, 11/842,921, and 11/248,762, and U.S. Provisional Application Nos. 61/292,477 and 61/310,674 are incorporated herein by reference.

### FIELD OF THE INVENTION

This invention relates to electrical accessories for electrical devices, particularly electrical devices including media players and/or cellular telephones. More specifically, the invention relates to an electrical accessory configured to at least partially control one or more electrical devices, to transmit data signals received from one or more electrical devices to a speaker system, and/or to provide data signals to the one or more electrical device.

### DESCRIPTION OF THE BACKGROUND

Numerous types of electrical devices are portable, such as, for example, cellular (or mobile) telephones, laptop computers, audio playback devices, AM (amplitude modulated) and FM (frequency modulated) radios, CD (compact disk) players, and media (e.g., MP3 (MPEG Audio Layer-3)) players. The terms “electrical device” and “media device” should be broadly understood and include electrical devices of all types and designs (e.g., media players, telephones, audio-visual media players, and devices incorporating media players, telephones, and/or audio-visual devices).

There are many portable electrical devices available, including those manufactured by Sony Corp., Philips Corp., Audiovox Corp., Microsoft Corp. (e.g., the Zune™ MP3 player), Research in Motion Limited (e.g., the Blackberry® device), Palm, Inc. (e.g., the Palm® device), and Apple Computer, Inc. (e.g., the iPod® MP3 player, the iTouch® device, and the iPhone® device). These electrical devices rely on batteries for their portability and typically utilize headsets, ear phones, or a small built-in speaker for user listening. Battery life is sometimes a problem. After a few hours of usage, most of these electrical devices need an alternate power source, need to be charged, or need to have their batteries replaced. Another limitation is that these electrical devices typically play sound for only one listener at a time (e.g., via headset or ear phones). Even if the electrical device is equipped with a speaker, the device's small size and light-weight design limit the size of the speaker, which tends to make the speaker inadequate for transmitting music to a group of people, e.g., in a vehicle.

Electrical accessories that attempt to overcome these limitations are available, for example, units to supply power to the electrical devices for operation and/or charging and FM transmission systems. An FM transmission system when used in conjunction with electrical devices allows the user to play music files stored on the electrical devices through an FM audio system so that one can listen and allow others to listen to the stored music. However, current FM transmission systems are often unstable and provide weak FM signals, which can result in a loss of the signal or a constant static hiss in the background. In such known FM transmission systems, the FM signal strength is sometimes weakened or lost because of inefficient antenna design (e.g., concerning its size, shape, and/or location).

Another common problem with electrical devices is that these electrical accessories are designed to work with only a limited set of the capabilities of the electrical devices. For examples, many electrical accessories can receive audio (e.g., audio files) from the electrical devices, but are not integrated with the other features (e.g., telephonic features) of the electrical device. Furthermore, another common problem with electric accessories are that the electrical accessories are configured to work with only a single electrical device at any time. In many cases, a user will have two or more electrical devices, he or she wants to use with the electrical accessory, but the electrical accessory is designed to work with only a single electrical device at any time.

Accordingly, a need exists for an apparatus or accessory that allows a user to easily utilize the full breath of capabilities of two or more electrical devices including media players, telephones, and/or audio-visual devices.

### BRIEF DESCRIPTION OF THE DRAWINGS

To facilitate further description of the embodiments, the following drawings are provided in which:

FIG. 1 illustrates an overview of a system for transmitting data signals between electrical devices, a receiving device, and an electrical accessory, according to a first embodiment;

FIG. 2 illustrates an isometric view of the electrical accessory of FIG. 1, according to the first embodiment;

FIG. 3 illustrates a block view of the electrical accessory of FIG. 1, according to the first embodiment;

FIG. 4 illustrates another block view of the electrical accessory of FIG. 1, according to the first embodiment;

FIG. 5 illustrates an overview of a system for transmitting data signals between an electrical device, a receiving device, and an electrical accessory, according to a second embodiment;

FIG. 6 illustrates a block view of the electrical accessory of FIG. 5, according to the second embodiment;

FIG. 7 illustrates an overview of a system for transmitting data signals between an electrical device, a receiving device, and an electrical accessory, according to a third embodiment;

FIG. 8 illustrates a block view of an electrical accessory, according to a fourth embodiment;

FIG. 9 illustrates a block view of an electrical accessory, according to a fifth embodiment;

FIG. 10 illustrates a block view of an electrical accessory, according to a sixth embodiment;

FIG. 11 illustrates an isometric view of an electrical accessory, according to a seventh embodiment;

FIG. 12 illustrates an example of a method of using an electrical accessory, according to an embodiment; and

FIG. 13 illustrates an example of a method of providing an electrical accessory, according to an embodiment.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

### DETAILED DESCRIPTION OF EXAMPLES OF EMBODIMENTS

In some embodiments, an electrical accessory can be configured to transmit one or more first data signals to a receiving device. The electrical accessory can include: (a) a first electrical interface configured to mechanically and electrically couple to a first connector of a first electrical device, the first electrical interface further configured to receive a first part of the one or more first data signals from the first electrical device; (b) a first transmitter configured to transmit one or more second data signals to a second electrical device; (c) a first receiver configured to receive a second part of the one or more first data signals from the second electrical device; (d) a second transmitter electrically coupled to the first electrical interface and the first receiver, the second transmitter configured to transmit the one or more first data signals to the receiving device; (e) a first microphone electrically coupled to the first transmitter and configured to receive sounds and convert the sounds into the one or more second data signals; and (f) a controller electrically coupled to the first transmitter, the first receiver, the second transmitter, and the first microphone. The controller can be configured such that the controller instructs the first electrical device to stop providing the first part of the one or more first data signals before or when the first receiver receives the second part of the one or more first data signals from the second electrical device.

In other embodiments, an apparatus can be configured to couple to a first media device. The apparatus can include: (a) a Bluetooth module configured to transmit first data to the first media device and receive second data from the first media device; (b) at least one first control configured to at least partially operate the first media device; (c) a communications module electrically coupled to the Bluetooth module, the communications module is configured to transmit the second data received from the first media device to an external speaker system over at least one frequency modulated radio frequency; (d) a microphone electrically coupled to the Bluetooth module and configured to provide the first data to the Bluetooth module; and (e) a power acquisition unit configured to couple to an external electrical power source and configured to provide electrical power to at least the Bluetooth module, the microphone, the communications module, and the at least one first control.

In still further embodiments, a method of using an electrical accessory can include: receiving a first stream of first data signals; transmitting the first stream of the first data signals; receiving one or more second data signals; stopping the transmitting of the first stream of the first data signals; receiving a second stream of third data signals; transmitting the second stream of the third data signals; and starting to transmit the first stream of the first data signals after receiving the second stream of the second data signals.

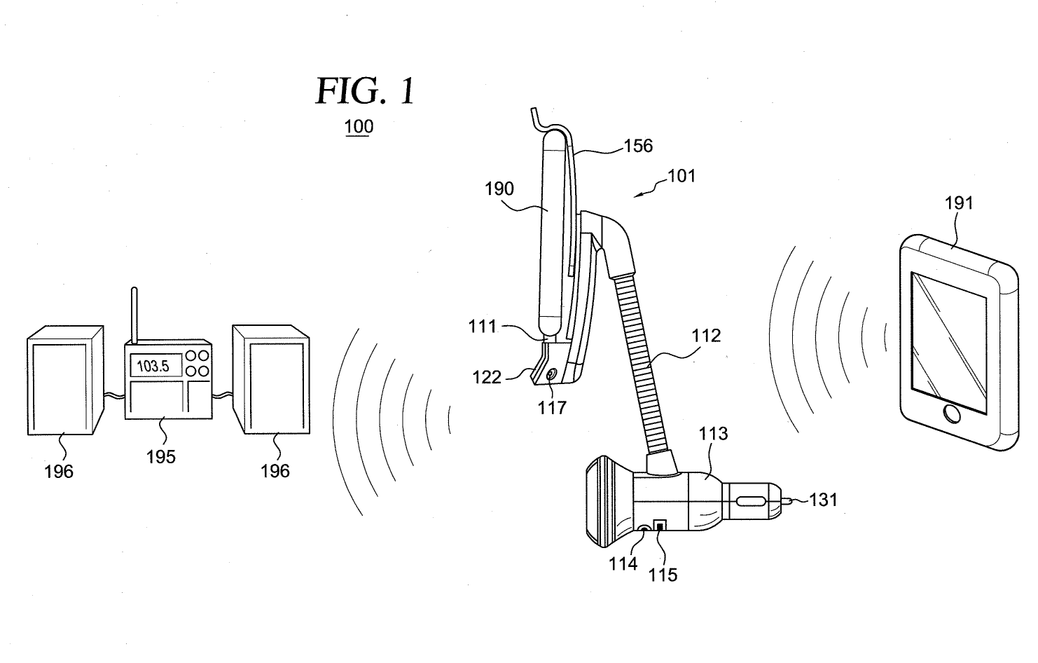

FIG. 1 illustrates an overview of a system 100 for transmitting data signals between electrical devices 190 and 191, a receiving device 195, and electrical accessory 101, according to a first embodiment. System 100 is merely exemplary and is not limited to the embodiments presented herein. System 100 can be employed in many different embodiments or examples not specifically depicted or described herein.

As illustrated in FIG. 1, in some examples, electrical accessory 101 can be configured to transmit one or more data signals from electrical device 190 and/or 191 to receiving device 195. Receiving device 195 can broadcast the data signals using speakers 196.

In some embodiments, electrical accessory 101 can wirelessly transmit the data signals to receiving device 195. In one example, the data signals can be wirelessly transmitted over a radio frequency. In another example, the data signals can be wirelessly transmitted using a Bluetooth™ connection between electrical accessory 101 and receiving device 195. In other embodiments, electrical accessory 101 can transmit the data signals to receiving device 195 over a wired connection.

In some examples, electrical accessory 101 can also be coupled to electrical device 190 using electrical coupling 111. For example, electrical device 190 can be an iPod® device or an iTouch® device, and electrical device 190 can be coupled to electrical accessory 101 using a thirty pin dock connector. Electrical accessory 101 can receive data signals (e.g., music or other audio signals) from electrical device 190 through electrical coupling 111 and transmit the data signals to receiving device 195.

In various examples, electrical device 191 and electrical accessory 101 can be in communication using a wireless signal. In this example, electrical accessory 101 can receive data signals (e.g., music or audio signals from a telephone call) over the wireless signal and transmit the data signals to receiving device 195. For example, electrical device 191 can include a cellular telephone (e.g. a Blackberry® device or iPhone® device) and can be wirelessly coupled to electrical accessory 101 using a Bluetooth connection.

In some examples, electrical device 191 includes a cellular telephone and receives a telephone call. The data signals transmitted from electrical accessory 101 to receiving device 195 can be the incoming audio from the telephone call, and the data signals provided to electrical device 191 from electrical accessory 101 can be the outgoing audio. In these examples, electrical accessory 101 and receiving device 195 can function as a speaker system (i.e., a speaker phone) for electrical device 191 with the speakers, for example, being a vehicle speaker system. Microphone 117 can receive sounds (e.g., a user's voice) and convert the sounds into data signals that are provided to electrical device 191.

In still further embodiments and as illustrated in FIG. 1, electrical device 190 can be coupled to electrical accessory 101 using electrical coupling 111. Simultaneously with the coupling between electrical accessory 101 and electrical device 190, electrical device 191 and electrical accessory 101 can be in communication using a wireless signal. For example, electrical device 191 can be paired to electrical accessory 101 using a Bluetooth wireless protocol. In these embodiments, electrical accessory 101 can be transmitting data signals (e.g., music) from electrical device 190 to receiving device 195 when a telephone call is received by electrical device 191. When electrical device 191 communicates to electrical accessory 101 that a telephone call is being received, electrical accessory 101 can pause or stop the data signals (e.g., music) from electrical device 190 being transmitted to receiving device 195. For example, electrical accessory 101 can automatically instruct electrical device 190 to stop or pause the data signals (e.g., music). In some examples, the data signals (e.g., music) from electrical device 190 can be faded out.

Then, electrical accessory 101 can also answer the telephone call and begin transmitting the data signals (i.e., the incoming audio for the telephone call) to receiving device 195. In some examples, the telephone call is answered automatically. In other examples, the user can press a button on electrical device 191 or electrical accessory 101 (e.g., button 122) to begin (and/or end) the telephone call.

After the telephone call is ended, electrical accessory 101 can instruct electrical device 190 to unpause or restart the data signals (e.g. the music) and transmit the data signals (e.g. the music) from electrical device 190 to receiving device 195. In some embodiments, electrical accessory 101 can issue the instruction automatically after the telephone call is ended.

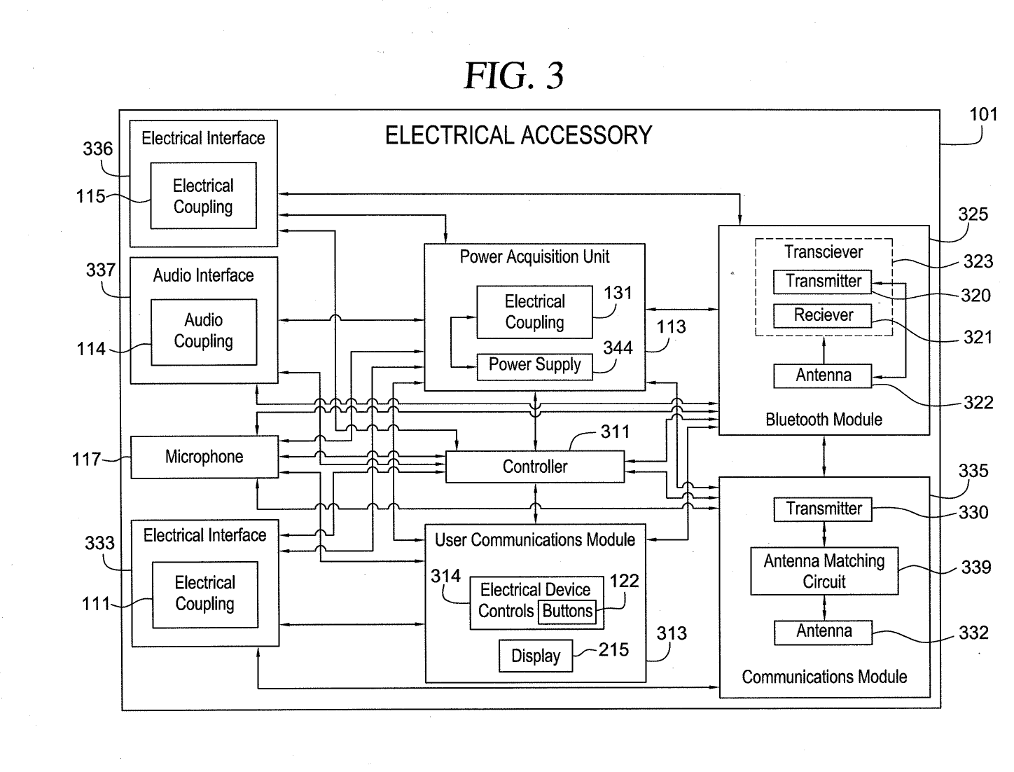

In the same or different embodiments, electrical accessory 101 can also at least partially control electrical device 190 or 191 using electrical device controls 314 (FIG. 3). In some examples, electrical device controls 314 (FIG. 3) can include a single button 122 that allows the user to answer and/or end a telephone call, and/or to play, pause, fast forward and/or rewind audio being played on electrical device 190 or 191.

In some embodiments, electrical devices 190 and 191 can be electrical devices configured to produce and receive electrical signals. For example, electrical device 190 and/or 191 can be a cellular (or mobile) phone, a laptop computer, an audio playback device, a portable AM (amplitude modulated) and FM (frequency modulated) radio, a satellite radio, a portable CD (compact disk) player, a data storage device, an audio player, an audio-visual player, and/or a portable media (e.g., MP3) player.

Receiving device 195 can be any electrical device that includes a receiver configured to receive radio frequency (or other high frequency) signals. In some embodiments, receiving device 195 can be a FM and/or AM radio. Receiving device 195 can include or be coupled to one or more speakers 196. For example, if receiving device 195 is a car radio, the car radio can be electrically coupled to the car's speaker system.

A “Bluetooth wireless protocol,” as used herein, is a standard and a communications protocol for exchanging electrical signals over short distances. In some examples, the Bluetooth wireless protocol refers to the Bluetooth 3.0+HS (High Speed) specification, adopted by the Bluetooth SIG (Special Interest Group) on Apr. 29, 2009. In other examples, the Bluetooth wireless protocol refers to other versions of the Bluetooth wireless protocol, for example, Bluetooth 2.1+EDR (Enhanced Data Rate) adopted by the Bluetooth SIG on Jul. 26, 2007. The Bluetooth 3.0+HS specification and the Bluetooth 2.1+EDR specification are incorporated herein by reference. The Bluetooth wireless protocol can also refer to a Bluetooth specification adopted subsequent to the Bluetooth 3.0+HS specification. In some examples, electrical devices communicate using the Bluetooth wireless protocol over a 2.4 GHz (gigahertz) band. In various embodiments, transmitters and receivers that use the Bluetooth wireless protocol can be referred to as Bluetooth transmitters and Bluetooth receivers, respectively. In some examples, the set of radio frequencies used by electrical accessory 101 to transmit the data signals to receiving device 195 can include the full FM band. In the United States (US), the FM band includes the frequencies or channels between 88.1 MHz (megahertz) and 108 MHz. In Japan, the FM band includes frequencies between 76 MHz and 90 MHz. In Europe, the FM band includes frequencies between 87.6 MHz and 107.9 MHz. In other countries, the full FM band can span other ranges of radio frequencies. In further embodiments, the set of radio frequencies include other carrier frequency sets or bands (e.g., the AM (amplitude modulated) band, the VHF (very high frequency) band, and/or the UHF (ultra high frequency) band).

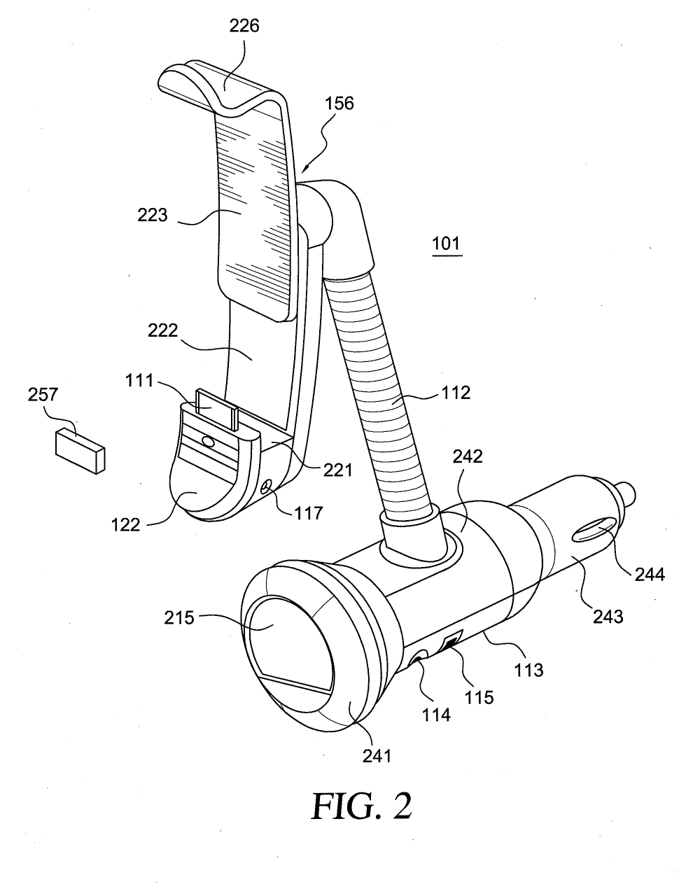

FIG. 2 illustrates an isometric view of electrical accessory 101, according to the first embodiment. FIG. 3 illustrates a block view of electrical accessory 101, according to the first embodiment. Electrical accessory 101 is merely exemplary and is not limited to the embodiments presented herein. Electrical accessory 101 can be employed in many different embodiments or examples not specifically depicted or described herein.

Referring to FIGS. 1-3, an apparatus or electrical accessory 101 can include: (a) a cradle or holder 156 configured to hold or couple to electrical device 190 and/or 191; (b) a connector 112; (c) a power acquisition unit 113 configured to receive electrical power from an external power source; (d) at least one electrical interface 333 and 336; (e) a controller 311; (f) a user communications module 313; (g) at least one microphone 117; (h) communications module 335; (i) a Bluetooth module 325; and (j) at least one audio interface 337.

In some embodiments, electrical interface 333 can include an electrical coupling 111 and electrical circuitry (if any) needed to use electrical coupling 111. Electrical interface 333 can be electrically coupled to power acquisition unit 113, user communications module 313, communications module 335, and controller 311. Electrical coupling 111 can be configured to mechanically and electrically couple to a first connector of electrical device 190 and/or 191. Electrical interface 333 can be further configured to receive data signals from the electrical device and provide the data signals to communications module 335. For example, electrical coupling 111 can be a thirty-pin male connector configured to mechanically and electrically couple to a thirty-pin female connector (not shown) on electrical device 190 (e.g., a thirty pin dock connector on the iPhone® device, iTouch® device, and some iPod® devices).

In some examples, electrical accessory 101 can send instructions to electrical device 190 using electrical interface 333. For example, controller 311 can send instructions to electrical device 190 to start, pause, or stop providing data signals through electrical coupling 111

Bluetooth module 325 can be configured to transmit data signals to electrical device 191 and receive data signals from electrical device 191, without being physically coupled to electrical device 191. In some examples, Bluetooth module 325 can include: (a) at least one transmitter 320; (b) at least one receiver 321; and (c) an antenna 322.

Transmitter 320 can be electrically coupled to antenna 322 and be configured to transmit data signals using a Bluetooth wireless protocol (i.e., transmitter 320 can be a Bluetooth transmitter). Transmitter 320 can be electrically coupled to microphone 117 and audio interface 337 and configured to transmit data signals (e.g., audio) to electrical device 190. In some examples, microphone 117 can covert sounds into data signals, and transmitter 320 can transmit the data signals to electrical device 191.

Receiver 321 can be electrically coupled to antenna 322 and configured to receive data signals using a Bluetooth wireless protocol (i.e., receiver 321 can be a Bluetooth receiver). Receiver 321 can be electrically coupled to transmitter 330 of communications module 335. In some examples, receiver 321 can receive the data signals (e.g., audio) from electrical device 191 and provide the data signals to transmitter 330. In some examples, the data signals include voice signals from a telephone call. In various examples, a transceiver 323 can include transmitter 320 and receiver 321. In other examples, a receiver 321 and a transmitter 320 separate from receiver 321 can be used.

In other embodiments, transmitter 320 and receiver 321 can communicate using protocols other than the Bluetooth wireless protocol. For example, transmitter and receiver 321 can communicate using WI-FI (wireless fidelity) IEEE (Institute of Electrical and Electronics Engineers) 802.11 wireless protocol.

Communications module 335 can be electrically coupled to Bluetooth module 325. Communications module 335 can be configured to transmit the data signals received from electrical devices 190 and/or 191 to receiving device 195 (i.e., an external speaker system). In various examples, communications module 335 can transmit the data signals over a FM radio frequency. Communications module 335 can include: (a) at least one transceiver or transmitter 330 electrically coupled to Bluetooth module 325; (b) an antenna matching circuit 339 electrically coupled to transmitter 330; and (c) an antenna 332 electrically coupled to antenna matching circuit 339. In some examples, electrical accessory 101 can include a mechanism that allows a user to select a radio frequency over which the data signals are transmitted by transmitter 330. In the same or different example, electrical accessory can manually, automatically, or semi-automatically select the radio frequency.

In some examples, communications module 335 is configured to transmit data signals from electrical device 190 to receiving device 195 until communications module 335 is instructed to begin transmitting data signals from electrical device 191 to receiving device 195.

Transmitter 330 can be configured to transmit data signals over the radio frequency using antenna 332. Transmitter 330 can be configured to transmit data signals (e.g., audio) to external speakers 196 coupled to receiving device 195. In many examples, transmitter 330 includes a FM and/or AM radio frequency transmitter. Transmitter 330 can be coupled to antenna 332 through antenna matching circuit 339. In some examples, transmitter can be configured to transmit the data signals over one or more frequencies in the set of radio frequencies.

To comply with FCC (Federal Communications Commission) requirements, the output of transmitter 330 (electrical signals) is coupled to an attenuation circuit (not shown). The amount of attenuation that is needed to comply with FCC requirements is dictated by the output of the particular transmitter, the quality, and type of antenna that is being utilized, and the environment in which the transmitter is being used. Consequently, the specific design of the attenuation circuit is a matter of design choice depending upon the needs of the particular application. For some types of electrical signals to be transmitted by transmitter 330, an attenuation circuit will not be needed. In some embodiments, the attenuation circuit can be a portion of antenna matching circuit 339. In the same or different examples, transmitter 320 can also be coupled to an attenuation circuit (not shown). In some embodiments, electrical accessory 101 can be coupled to an external antenna (not shown) through an external antenna matching circuit (not shown) in addition to or instead of antenna 322 and/or 332.

Microphone 117 can be configured to receive sounds and convert the sounds into data signals. Microphone 117 can be electrically coupled to the Bluetooth module 325 and configured to provide data signals to Bluetooth module 325.

In some examples, microphone 117 can be located at holder 156. In other examples, microphone 117 is located at electrical power acquisition unit 113. In many embodiments, microphone 117 is located at holder 156, instead of electrical power acquisition unit 113 because locating microphone at holder 156 can provide better pick-up of voices and other audio.

User communications module 313 can include: (a) a first control or electrical device controls 314; and (b) at least one display 215. Electrical device controls 314 can include button 122 and the electrical circuitry to implement the electrical device controls. Electrical device controls 314 are configured to at least partially control electrical device 190 and/or electrical device 191. For example, button 122 can be used to begin and end a telephone call when electrical device 190 or 191 includes a cellular telephone. Button 122 can also be used to play, pause, fast forward, and rewind when electrical device 190 is configured to play music or other audio. In some examples, user communication module can also include one or more buttons to allow a user to select the radio frequency over which transmitter 330 will transmit the data signals.

In some embodiments, when electrical device 190 includes a media player, the providing of audio by electrical device 190 can be started with a push of button 122. A second push of button 122 can pause the audio. A third push of button 122 immediately after the second push (i.e., two pushes of button 122 in immediate succession) can be a signal that the user wants to fast forward the audio. A fourth push of button 122 immediately after the third push (i.e., three pushes of button 122 in immediate succession) can be a signal that the user wants to rewind or move to a previous portion of the audio. Other functionality can be implemented with other combinations of pushing of button 122 (e.g., five pushes of button 122 in immediate succession).

In embodiments where electrical device 190 or 191 includes a cellular telephone, instead of or in addition to a media player, when receiving an incoming telephone call, a push of button 122 can interrupt other functions (e.g., stop any playing audio) and answer the telephone call. Similarly, another push of button 122 can end the telephone call and automatically restart any other functions previously stopped when the telephone call was answered (e.g., resume playing the audio stopped when the telephone call was received). In another embodiment, the push of button 122 ends the telephone call, and a further push of button 122 is required to restart any other functions previously stopped.

In other examples, electrical device controls 314 can be implemented with two or more buttons. For examples, electrical device controls 314 can include a play/pause button, a stop button, a forward button, a back button, an answer/hang-up button, etc.

Although pushbuttons are shown in FIGS. 1-2, any type of button can be used, and the term “button” should be broadly understood to refer to any type of mechanism (with or without moving parts) whereby the user can input to electrical accessory 101 his or her data signals (for example, selection of a frequency), e.g., a mechanical pushbutton, an electrostatic pushbutton, an electrostatic array, or any other input device of any type.

Display 215 can be used to display information about a transmission frequency. For example, display 215 can display the carrier frequency at which transmitter 330 is transmitting data signals in the format “XXX.X.” In many examples, display 215 is an LCD (liquid crystal display). In other examples, display 215 can be a touch screen.

In some embodiments, audio interface 337 can include an audio coupling 114 and electrical circuitry (if any) needed to use audio coupling 114. In some examples, audio coupling 114 can be a female TRS (Tip, Ring, Sleeve) connector (e.g., a 2.5 millimeter (mm) or 3.5 mm female TRS connector), XLR jacks, RCA (Radio Corporation of America) plugs, ¼ inch stereo jack, and/or banana jacks. In some examples, audio output received from electrical device 190 through electrical coupling 115 can be provided to transmitter 330.

In some examples, audio coupling 114 can be configured to electrically and mechanically couple to receiving device 195 to provide the data signals from electrical device 190 or 191 to receiving device 195. In some examples, when audio coupling 114 is providing data signals to receiving device 195, transmitter 330 is not transmitting the data signals. In other examples, electrical accessory 101 does not include transmitter 330, and audio coupling 114 can be the only mechanism for communicating data signals to receiving device 195. In some examples, audio coupling 114 can be considered part of communications module 335.

In other examples, audio coupling 114 can be configured to couple to an external microphone or other external audio input devices to receive data signals. In some examples, the external audio input device can be used to provide data signals to electrical device 191 instead of or in addition to microphone 117.

In some embodiments, electrical interface 336 can include an electrical coupling 115 and electrical circuitry (if any) needed to use electrical coupling 115. Electrical interface 336 can be electrically coupled to power acquisition unit 113 and configured to provide electrical power to other electrical devices. In some examples, electrical coupling 115 can be a female universal serial bus connector.

Controller 311 can be electrically coupled to and at least partially control the operation of communications module 335, Bluetooth module 325, microphone 117, electrical interfaces 333 and 336, audio interface 337, and user communications module 313. For example, controller 311 can be a microprocessor, such as part no. C8051T611-GM manufactured by Silicon Laboratories, Inc. of Austin, Tex., or a microcontroller, such as part no. ST72F264G2H1 or STM8L151K4U6, manufactured by STMicroelectronics of Switzerland.

For example, controller 311 can be configured such that controller 311 can instruct electrical device 190 to stop providing data signals when receiver 321 begins to receive data signals from electrical device 191, and/or can instruct transmitter 330 to stop transmitting the data signals from electrical device 190, and/or can instruct electrical interface 333 to stop receiving the data signals from electrical device 190. Controller 311 can also be configured to instruct electrical device 190 to start providing data signals after receiver 321 stops receiving data signals from electrical device 191, and/or to instruction transmitter 330 to start transmitting the data signals from electrical device 191, and/or to instruct electrical interface to start receiving the data signals from electrical device 190. In many embodiments, controller 311 can start, stop, and/or pause the data signals by sending the instructions to electrical device 190 via electrical coupling 111.

In various embodiments, controller 311 can be further configured such that controller 311 can instruct transmitter 330 to stop providing data signals to receiving device 195 when audio interface 337 is electrically coupled to receiving device 195. In this situation, the data signals are provided to receiving device 195 via audio interface 337 (i.e., a wired connection) instead of via a wireless connection.

Furthermore, receiver 321 can be configured to receive a signal indicating that electrical device 191 is receiving a telephone call. When receiver 321 receive this signal, controller 311 can instruct electrical device 190 to stop provide data signals. In some examples, controller 311 can automatically send a signal to electrical device 191 instructing electrical device 191 to answer the telephone call.

In other examples, transmitter 330 can transmit the signal (e.g., a ringing sound) to receiving device 195, and controller 311 can wait for the user to press button 122 to instruct electrical device 191 to answer the telephone call. If the user presses button 122, controller 311 sends a signal to electrical device 191 instructing electrical device 191 to answer the telephone call, and transmitter 330 begins transmitting data signals from electrical device 191 to receiving device 195. If the user presses button 122 again, controller 311 can send a signal to electrical device 191 instructing electrical device 191 to end the telephone call. After the user presses button 122 to end the call or receiver 321 stops receiving data signals from electrical device 191, controller 311 can instruct electrical device 190 to begin sending data signals again (e.g., restart the music).

If the user does not press button 122 again, controller 311 can instruct electrical device 190 to begin sending data signals again after receiver 321 stop receiving the indications from electrical device 191.

Similarly, if electrical device 190 includes a cellular telephone and receives a telephone call, controller 311 can automatically instruct electrical device 190 to answer the telephone call or wait for the user to press button 122 to instruct electrical device 191 to answer the telephone call.

Holder 156 can be configured to mechanically couple to and hold electrical device 190. In some examples, holder 156 can include: (a) a base 221 configured to couple to electrical device 190 and/or electrical device 191; (b) one or more extensions 222 and 223 extending away from base 221; and (c) at least one clasp or support 226 coupled to extension 223.

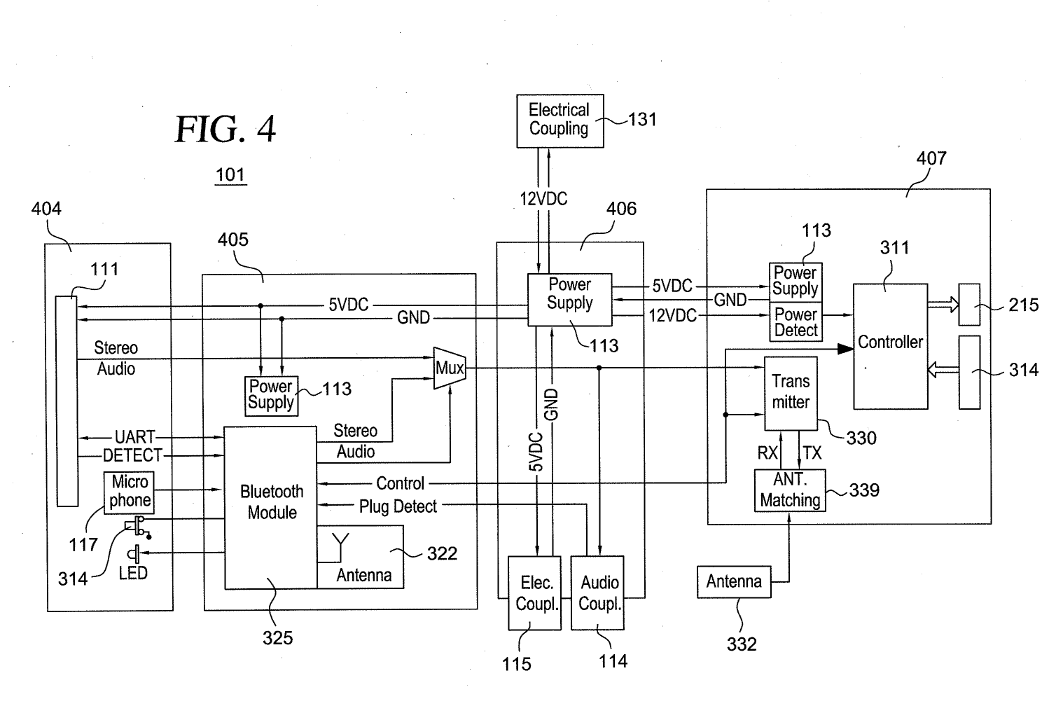

In many embodiments, base 221 can include an interior cavity (not shown). This interior cavity can house a portion of the electronic circuitry necessary to operate electrical accessory 101. For example, a portion of electrical interface 333, a portion of electrical device controls 314, and microphone 117 can be located in the interior cavity of base 221 (e.g., electrical circuitry board(s) 404 (FIG. 4)).

Base 221 can be coupled to extension 222. Support 226 can be coupled to extension 223. Extension 222 can be adjustably coupled to extension 223 such that a distance between base 221 and support 226 can be adjusted to correspond to the length or height of electrical device 190 or 191. For example, the distance can be adjusted in the range of approximately 65 millimeters to approximately 120 millimeters.

Support 226 can be coupled to extension 223 such that the combination of support 226, extensions 222 and 223, base 221, and electrical coupling 111 securely holds electrical device 190 and/or 191 to electrical accessory 101.

In some examples, holder 156 can be configured to hold an electrical device that does not mate with electrical coupling 111. In these examples, holder 156 can include a cap 257 that can be placed over electrical coupling 11 to facilitate the coupling of the electrical device to holder 156.

Connector 112 can be a semi-rigid elongated portion configured to allow a position of holder 156 to be semi-permanently adjusted relative to a position of the power acquisition unit 113. In some examples, connector 112 can include a gooseneck, which can be compliant (or obedient) flexible tubing, and is preferably metallic or metal covered with, e.g., plastic or elastic material on its outside.

A gooseneck can be considered to be a coiled layered construction in which adjacent coils overlap but can be moved with respect to each other (in a sense, slide on each other). A goosenecks tends to hold the position into which it is bent (i.e., it is semi permanently adjustable or repositionable), unless it is bent beyond its limit. The two “layers” of the gooseneck can be considered to have different thicknesses. Thus, a gooseneck has two outer diameters, the outer diameter of the thicker layer, and the outer diameter of the thinner layer, which alternate in the gooseneck.

Connector 112 must not be so stiff that it cannot be readily repositioned by the user; however, it must be stiff enough to maintain holder 156 (with electrical device 190) in position with respect to power acquisition unit 113 after holder 156 and connector 112 have been put into their desired position.

Connector 112 used in some embodiments is available in varying dimensions (e.g., outer diameters of 2 millimeter or less to over 16 millimeters). Connector 112 can be implemented with a design, dimensions, and materials of construction to select for any particular usage based on the desired length of connector 112, the weight of holder 156 and electrical device 190 to be held in it, and whether connector 112 is to function as a broadcast antenna and, if so, for what range of radio frequencies.

As shown in FIGS. 1 and 2, power acquisition unit 113 includes: (a) an end portion 241; (b) a middle portion 242; (c) an end portion 243; (d) an electrical coupling 131; and (e) a power supply 344. Connector 112 can be coupled to middle portion 242. In other examples, connector 112 can be coupled to end portion 241 or 243. In some examples, end portion 241 has a larger diameter than middle portion 242, and middle portion 242 has a larger diameter than end portion 243.

In numerous embodiments, an internal cavity exists inside of end portion 241, end portion 243, and/or middle portion 242. This internal cavity can contain the electrical circuitry for obtaining power from an external power source (e.g., electrical circuitry board(s) 406 (FIG. 4)) such as a cigarette lighter, and then processing the electrical power (i.e., the circuitry for the cigarette lighter adapter). The internal cavity can also contain at least electrical circuitry for Bluetooth module 325, communications module 335, controller 311, and button 122 and/or display 215 (e.g., electrical circuitry board(s) 405 and 407 (FIG. 4)).

Although power acquisition unit 113 is preferably removably coupleable to an external power source (e.g., cigarette lighter), power acquisition unit 113 can in some cases be permanently affixed to the external power source. For example, a driver of a vehicle who does not smoke may obtain electrical accessory 101 and hard wire it into the cigarette lighter of the vehicle.

In some examples, power acquisition unit 113 is configured to couple to a cigarette lighter of a vehicle using electrical coupling 131. That is, electrical coupling 131 can includes a cigarette lighter adapter. End portion 243 can be configured to be inserted into an external power source such as the cigarette lighter of a vehicle, which is usually a cylindrical cavity. To help position and stabilize power acquisition unit 113 in such a cavity, non-conductive stabilizing springs 244 are provided on opposite sides of end portion 243.

FIG. 4 illustrates another block diagram of electrical accessory 101, according to the first embodiment. In various examples, electrical accessory 101 can include four or more electrical circuitry boards 404, 405, 406, and 406. In one example, microphone 117, at least a part of electrical device controls 314, and electrical coupling 111 can be located on or electrically coupled to electrical circuitry board(s) 404. Bluetooth module 325, antenna 322, and part of power acquisition unit 113 can be located on board 405. At least a part of power acquisition unit 113 (e.g., part of the power supply), audio coupling 114, and electrical coupling 115 can be located on or electrically coupled to electrical circuitry board(s) 406. Transmitter 330, antenna matching circuit 339, controller 311, part of power acquisition unit 113, electrical device controls 314, and display 215 can be located on or electrically coupled to electrical circuitry board(s) 407.

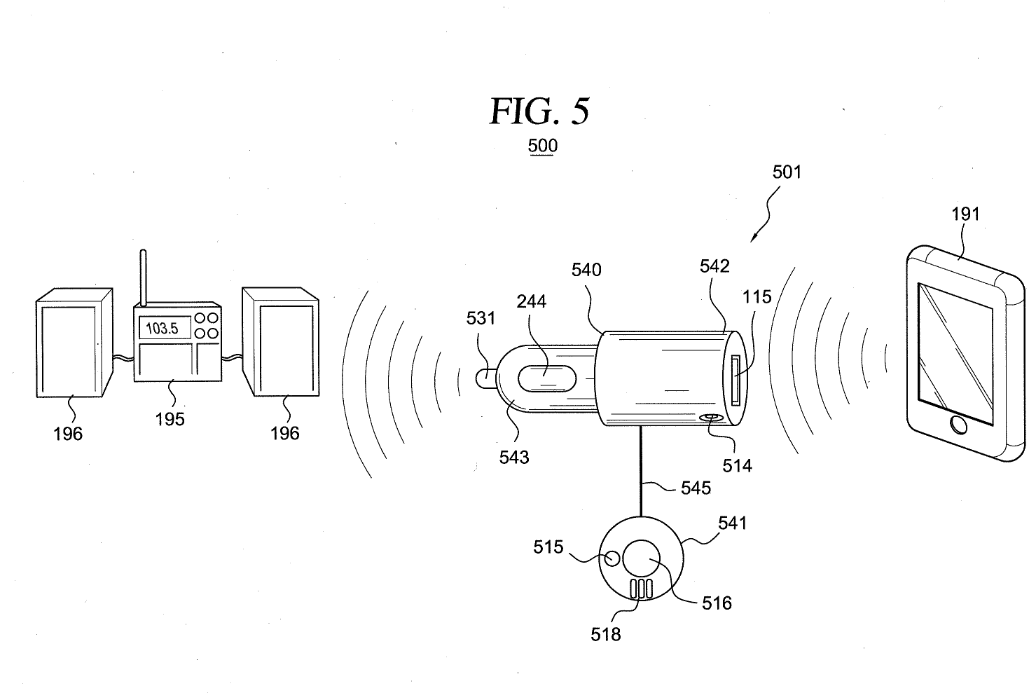

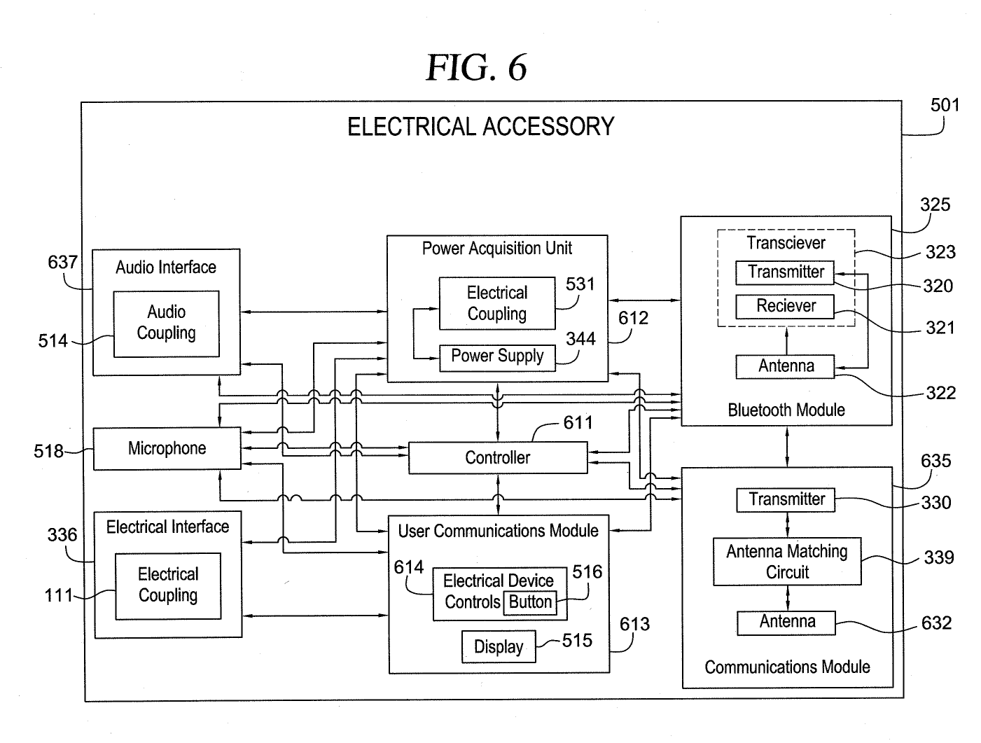

FIG. 5 illustrates an overview of a system 500 for transmitting data signals between electrical device 191, receiving device 195, and electrical accessory 501, according to a second embodiment. FIG. 6 illustrates a block view of electrical accessory 501, according to the second embodiment. System 500 and electrical accessory 501 are merely exemplary and are not limited to the embodiments presented herein. System 500 and electrical accessory 501 can be employed in many different embodiments or examples not specifically depicted or described herein.

In some examples, electrical accessory 501 can be configured to transmit one or more first data signals from electrical device 191 to receiving device 195 and also provide second data signals to electrical device 191.

Referring to FIGS. 5 and 6, an electrical device or electrical accessory 501 can include: (a) a controller 611; (b) a power acquisition unit 612; (c) a user communications module 613 with a display 515 and electrical device controls 614; (d) at least one microphone 518; (e) a communications module 635; (f) Bluetooth module 325; (g) at least one electrical interface 336; and (h) at least one audio interface 637.

Broadly speaking, in some embodiments, electrical accessory 501 can wirelessly receive data signals (e.g., using a Bluetooth wireless protocol) from electrical device 191 (e.g., an iPhone® device) device using receiver 321 and wirelessly transmit the data signals to receiving device 195 (e.g., a car stereo) over a radio frequency via transmitter 330. Microphone 518 can receive sounds and convert the sounds into data signals that are then wirelessly transmitted to electrical device 191 using transmitter 320 (e.g., using a Bluetooth wireless protocol). In some examples, electrical device 191 includes a cellular telephone, and the data signals transmitted from electrical accessory 501 to receiving device 195 are the incoming audio from the cellular telephone, and the data signals provided to electrical device 191 by electrical accessory 501 can be the outgoing audio. In these examples, electrical accessory 501 and receiving device 195 can function as a speaker system (i.e., a speaker phone) for electrical device 191 with the speakers, for example, being the car speaker system.

In the same or different embodiment, electrical device 191 can include a media player. Electrical accessory 501 can wirelessly receive data signals from electrical device 191 using receiver 321 and wirelessly transmit the data signals to receiving device 195 (e.g., a car radio and speaker system) over a radio frequency using transmitter 330.

In some examples, electrical accessory 501 can also at least partially control electrical device 191 using electrical device controls 614. In some examples, electrical device controls 614 can include a single button 516 that allows the user to answer or end a telephone call, or to play, pause, fast forward and/or rewind audio being played on electrical device 191.

In some examples, electrical accessory 501 can further include a main housing 540 and a peripheral housing 541. Peripheral housing 541 can be mechanically and electrically coupled to main housing 540 by an electrical cord 545. In various embodiments, peripheral housing 541 can include an attachment mechanism (not shown) to couple the peripheral housing 541 to a surface (e.g., a dashboard of a vehicle). In some examples, the attachment mechanism can be an adhesive or Velcro® material.

Main housing 540 can include a back portion 543 and a front portion 542. In some examples, front portion 542 has a larger diameter than back portion 543. Back portion 543 can be configured to be inserted into an external power source such as the cigarette lighter of a vehicle, which is usually a cylindrical cavity. To help position and stabilize back portion 543 in such a cavity, non-conductive stabilizing springs 244 are provided on opposite sides of back portion 543.

In numerous embodiments, an internal cavity (not shown) exists inside of main housing 540. The internal cavity can also contain at least a portion of controller 611, power acquisition unit 612, transmitter 330, Bluetooth module 325, electrical interface 336, antenna matching circuit 339, and antenna 632. In the same or different examples, peripheral housing 541 can house at least a portion of microphone 518, display 515, and user communications module 613.

In some embodiments, controller 611 can be electrically coupled to and at least partially control the operation of portions of transmitter 330, Bluetooth module 325, microphone 518, electrical interface 336, audio interface 637, and user communications module 613. In some examples, controller 611 can be similar or identical to controller 311.

Power acquisition unit 612 can include electrical coupling 531 and the electronic circuitry (if any) necessary to electrically couple to and draw electrical power from an external power source. Power acquisition unit 612 can be configured to couple to an external electrical power source and configured to provide electrical power to at least one or more of controller 611, transmitter 330, Bluetooth module 325, microphone 518, electrical interface 336, audio interface 637, and user communications module 613. In some examples, power acquisition unit 612 is configured to couple to a cigarette lighter of a vehicle. That is, electrical coupling 531 can includes a cigarette lighter adapter. In some examples, power acquisition unit 612 can be similar or identical to power acquisition unit 113.

Microphone 518 can be electrically coupled to transmitter 320 and configured to provide data signals to transmitter 320. In some examples, at least a portion of microphone 518 can be located at peripheral housing 541. In other examples, microphone 518 can be located at main housing 540. In many embodiments, microphone 518 is located at peripheral housing 541 instead of main housing 540 because locating microphone at peripheral housing 541 can provide better pick-up of voices and other audio. In some examples, microphone 518 can be similar or identical to microphone 117 of FIG. 1.

Electrical device controls 614 can include a button 516 and the electrical circuitry to implement the electrical device controls. Electrical device controls 614 are configured to at least partially control electrical device 191. In some examples, electrical device controls 614 and button 516 can be similar or identical to electrical device controls 314 and button 122, respectively, of FIG. 1.

Audio interface 637 can include at least one audio coupling 514 and the electronic circuitry (if any) necessary for audio coupling 536. In some embodiments, electrical device 190 (FIG. 1) can be coupled to electrical accessory 501 using audio coupling 514. In these examples, electrical accessory 501 can function similar or identical to electrical accessory 101. For example, when electrical device 190 (FIG. 1) is coupled to electrical accessory 501 using audio coupling 536, electrical accessory 501 can receive data signals (e.g., music) from electrical device 190 (FIG. 1) and transmit the data signals (e.g., music) to receiving device 195 until electrical device 191 receives a telephone call. When electrical device 191 receives a telephone call, electrical accessory can instruct electrical device 190 (FIG. 1) to stop or pause providing data signals and transmitter 330 can transmit data signals (e.g., the incoming audio for the telephone call) until the telephone call is complete. When the telephone call is complete, controller 611 can instruct electrical device 190 (FIG. 1) to start providing data signals (e.g., music) via audio coupling 514, and transmitter 330 can transmit the data signals from electrical device 190 (FIG. 1) to receiving device 195.

In other examples, an external microphone or other external audio input device can be coupled to audio interface 637 to provide data signals to electrical device 191 and/or receiving device 195. In some examples, the external audio input device can be used to provide data signals to electrical device 191 instead of or in addition to microphone 518. In other examples, audio coupling 514 can be coupled to one or more external speakers and provide audio from electrical device 191 to the external speakers. In various embodiments, audio coupling 514 can include a female TRS connector, XLR jacks, RCA plugs, ¼ inch stereo jack, and/or banana jacks.

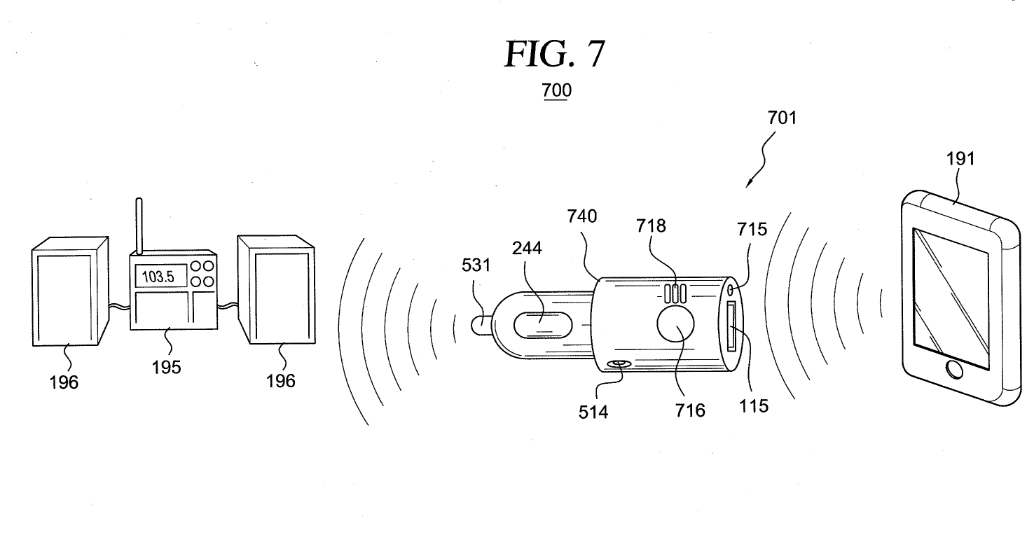

Turning to another embodiment, FIG. 7 illustrates an overview of a system 700 for transmitting data signals between an electrical device 191, a receiving device 195, and electrical accessory 701, according to a third embodiment. System 700 and electrical accessory 701 are merely exemplary and are not limited to the embodiments presented herein. System 700 and electrical accessory 701 can be employed in many different embodiments or examples not specifically depicted or described herein.

In the embodiment shown in FIG. 7, electrical accessory 701 includes a main housing 740, but not a peripheral housing. Microphone 718, electrical device control(s) 716, and display 715 can be located at main housing 740, instead of a peripheral housing.

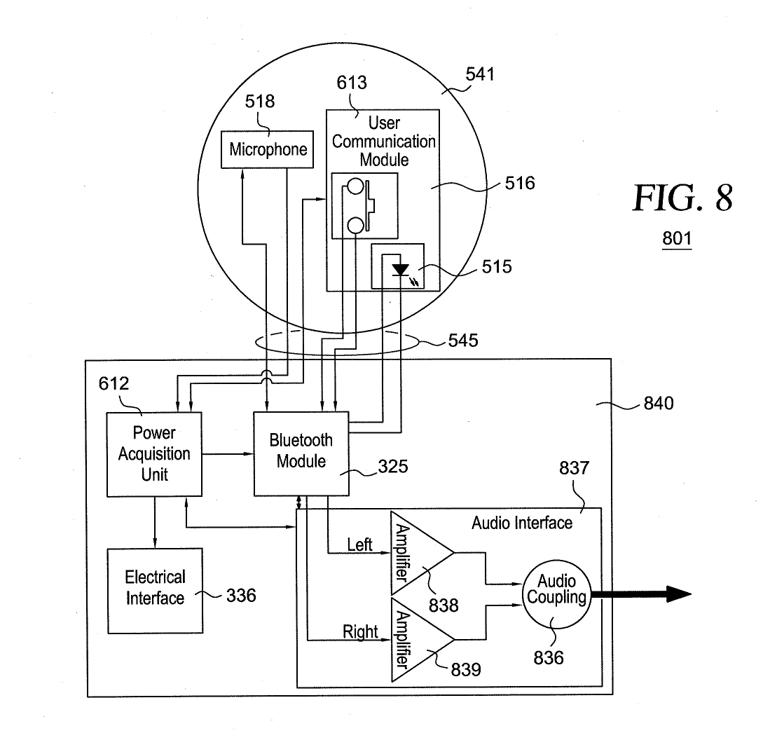

FIG. 8 illustrates a block view of electrical accessory 801, according to a fourth embodiment. In some examples, electrical accessory 801 can be configured to transmit one or more first data signals from electrical device 191 (FIGS. 1, 5, and 7) to receiving device 195 (FIGS. 1, 5, and 7) and also provide second data signals to electrical device 191 (FIGS. 1, 5, and 7). Electrical accessory 801 is merely exemplary and is not limited to the embodiments presented herein. Electrical accessory 801 can be employed in many different embodiments or examples not specifically depicted or described herein.

Referring to FIG. 8, an electrical device, or electrical accessory 801 can include: (a) a power acquisition unit 612; (b) a user communications module 613; (c) at least one microphone 518; (d) Bluetooth module 325; (e) at least one electrical interface 336; and (f) at least one audio interface 837. In other embodiments, electrical accessory 801 can also include a controller (not shown). In some examples, electrical accessory 801 can further include a main housing 840 and peripheral housing 541. In one embodiment, electrical accessory 801 in FIG. 8 can be similar to electrical accessory 501 in FIGS. 5 and 6, except that audio interface 837 in FIG. 8 replaces audio interface 637 in FIG. 6.

Broadly speaking, in some embodiments, electrical accessory 801 can wirelessly receive data signals (e.g., using a Bluetooth wireless protocol) from electrical device 191 (FIGS. 1, 5, and 7) using receiver 321 (FIG. 3) and transmit the data signals to receiving device 195 (FIGS. 1, 5, and 7) (e.g., a car stereo) using audio coupling 514 (e.g., a stereo jack). Microphone 518 can receive sounds and convert the sounds into data signals that are then wirelessly transmitted to electrical device 191 (FIGS. 1, 5, and 7) using transmitter 320 (FIG. 3) (e.g., using a Bluetooth wireless protocol). In some examples, electrical device 191 (FIGS. 1, 5, and 7) includes a cellular telephone, and the data signals transmitted from electrical accessory 801 to receiving device 195 (FIGS. 1, 5, and 7) are the incoming audio from the cellular telephone, and the data signals provided to electrical device 191 (FIGS. 1, 5, and 7) by electrical accessory 801 can be the outgoing audio. In these examples, electrical accessory 801 and receiving device 195 (FIGS. 1, 5, and 7) can function as a speaker system (i.e., a speaker phone) for electrical device 191 (FIGS. 1, 5, and 7) with the speakers, for example, being the car speaker system.

In the same or different embodiment, electrical device 191 (FIGS. 1, 5, and 7) can include a media player. Electrical accessory 801 can wirelessly receive data signals from electrical device 191 (FIGS. 1, 5, and 7) using receiver 321 (FIG. 3) and transmit the data signals to receiving device 195 (e.g., a car radio and speaker system) via audio coupling 836.

Audio interface 837 can include at least one audio coupling 836 and the electronic circuitry (if any) necessary for audio coupling 836. In some examples, an external audio input device coupled to audio coupling 836 can be used to provide data signals to receiving device 195 (FIGS. 1, 5, and 7). In one example, audio interface 837 can include one or more amplifiers 838 and 839. In various embodiments, audio coupling 836 can include a female TRS connector, XLR jacks, RCA (plugs, ¼ inch stereo jack, and/or banana jacks. In some examples, audio interface 837 can be considered a communications module.

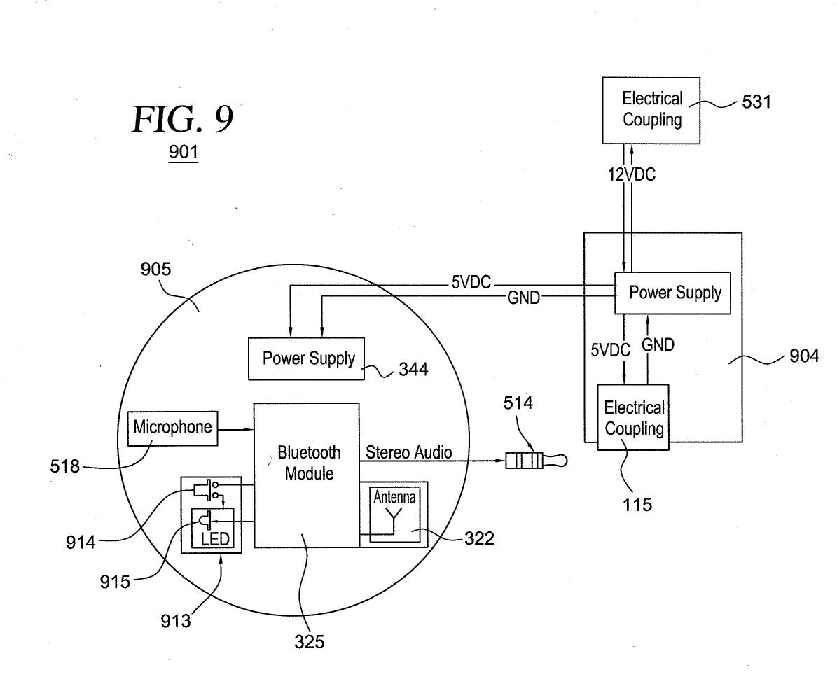

FIG. 9 illustrates a block view of electrical accessory 901, according to a fifth embodiment. In some examples, electrical accessory 901 can be configured to transmit one or more first data signals from electrical device 191 (FIGS. 1, 5, and 7) to receiving device 195 (FIGS. 1, 5, and 7) and also provide second data signals to electrical device 191 (FIGS. 1, 5, and 7). Electrical accessory 901 is merely exemplary and is not limited to the embodiments presented herein. Electrical accessory 901 can be employed in many different embodiments or examples not specifically depicted or described herein.

Referring to FIG. 9, an electrical device or electrical accessory 901 can include: (a) a power acquisition unit (not shown) with a power supply 344 and an electrical coupling 531; (b) user communications module 913 with a display 915 and electrical device control(s) 914; (c) at least one microphone 518; (d) Bluetooth module 325; (e) electrical coupling 115; and (f) at least one audio coupling 514. In other embodiments, electrical accessory 901 can also include a controller (not shown). In some examples, audio coupling 514 can be configured to couple to an audio coupling on receiving device 195 (FIGS. 1, 5, and 7). In one embodiment, electrical accessory 901 in FIG. 9 can be similar to electrical accessory 501 in FIGS. 5 and 6, except that user communications module 913 in FIG. 9 replaces user communicating module 613 in FIG. 6.

In some examples, at least a part of power supply 344 and electrical coupling 115 can be located at an electrical circuit board 904. In the same or different example, at least a part of power supply 344, Bluetooth module 325, microphone 518, and user communications module 913 can be located at electrical circuit board 905.

Broadly speaking, in some embodiments, electrical accessory 901 can wirelessly receive data signals (e.g., using a Bluetooth wireless protocol) from electrical device 191 (FIGS. 1, 5, and 7) using receiver 321 (FIG. 3) and transmit the data signals to receiving device 195 (FIGS. 1, 5, and 7) (e.g., a car stereo) using audio coupling 514 (e.g., a stereo jack). Microphone 518 can receive sounds and convert the sounds into data signals that are then wirelessly transmitted to electrical device 191 (FIGS. 1, 5, and 7) using transmitter 320 (FIG. 3) (e.g., using a Bluetooth wireless protocol). In some examples, electrical device 191 (FIGS. 1, 5, and 7) includes a cellular telephone, and the data signals transmitted from electrical accessory 901 to receiving device 195 (FIGS. 1, 5, and 7) are the incoming audio from the cellular telephone, and the data signals provided to electrical device 191 (FIGS. 1, 5, and 7) by electrical accessory 901 can be the outgoing audio. In these examples, electrical accessory 901 and receiving device 195 (FIGS. 1, 5, and 7) can function as a speaker system (i.e., a speaker phone) for electrical device 191 (FIGS. 1, 5, and 7) with the speakers, for example, being the car speaker system.

In the same or different embodiment, electrical device 191 (FIGS. 1, 5, and 7) can include a media player. Electrical accessory 901 can wirelessly receive data signals from electrical device 191 (FIGS. 1, 5, and 7) using receiver 321 (FIG. 3) and transmit the data signals to receiving device 195 (e.g., a car radio and speaker system) via audio coupling 514.

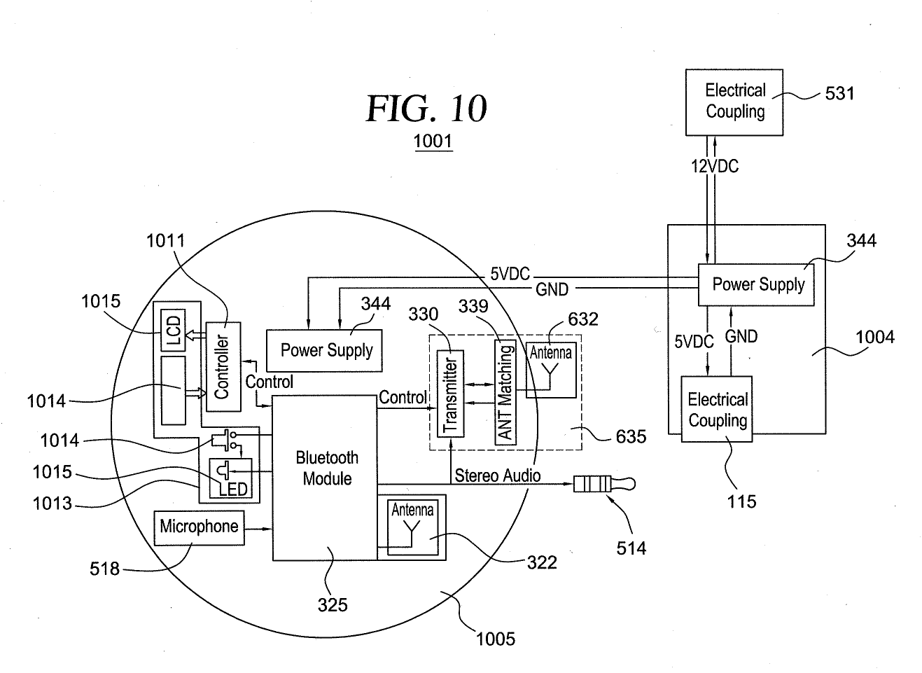

FIG. 10 illustrates a block view of electrical accessory 1001, according to a sixth embodiment. In some examples, electrical accessory 1001 can be configured to transmit one or more first data signals from electrical device 191 (FIGS. 1, 5, and 7) to receiving device 195 (FIGS. 1, 5, and 7) and also provide second data signals to electrical device 191 (FIGS. 1, 5, and 7). Electrical accessory 1001 is merely exemplary and is not limited to the embodiments presented herein. Electrical accessory 1001 can be employed in many different embodiments or examples not specifically depicted or described herein.

Referring to FIG. 10, an electrical device or electrical accessory 1001 can include: (a) a power acquisition unit (not shown) with a power supply 344 and a electrical coupling 531; (b) a user communications module 1013 with a display 1015 and electrical device control(s) 1014; (c) at least one microphone 518; (d) Bluetooth module 325; (e) electrical coupling 115; (f) at least one audio coupling 514; (g) a communications module 635 with a transmitter 330, antenna matching circuit 339, and antenna 632; and (h) controller 1011. In some examples, audio coupling 514 can be configured to couple to an audio coupling on receiving device 195 (FIGS. 1, 5, and 7). In one embodiment, electrical accessory 1001 in FIG. 10 can be similar to electrical accessory 501 in FIGS. 5 and 6, except that user communications module 1013 and controller 1011 in FIG. 10 replaces user communications module 613 and controller 611 in FIG. 6.

In various examples, display 1015 can comprise an LED and a liquid crystal display (LCD). Electrical device control(s) 1014 can include one button or two or more buttons.

In some examples, at least a part of power supply 344 and electrical coupling 115 can be located at an electrical circuit board 1004. In the same or different example, at least a part of power supply 344, at least a part of Bluetooth module 325, microphone 518, user communications module 1013, at least a part of communications module 635, and controller 1011 can be located at electrical circuitry board 1005.

Broadly speaking, in some embodiments, electrical accessory 1001 can wirelessly receive data signals (e.g., using a Bluetooth wireless protocol) from electrical device 191 (FIGS. 1, 5, and 7) using receiver 321 (FIG. 3) and transmit the data signals to receiving device 195 (FIGS. 1, 5, and 7) (e.g., a car stereo) using audio coupling 514 (e.g., a stereo jack) and/or transmitter 330 (e.g., over a FM radio frequency). Microphone 518 can receive sounds and convert the sounds into data signals that are then wirelessly transmitted to electrical device 191 (FIGS. 1, 5, and 7) using transmitter 320 (FIG. 3) (e.g., using a Bluetooth wireless protocol). In some examples, electrical device 191 (FIGS. 1, 5, and 7) includes a cellular telephone, and the data signals transmitted from electrical accessory 1001 to receiving device 195 (FIGS. 1, 5, and 7) are the incoming audio from the cellular telephone, and the data signals provided to electrical device 191 (FIGS. 1, 5, and 7) by electrical accessory 1001 can be the outgoing audio. In these examples, electrical accessory 1001 and receiving device 195 (FIGS. 1, 5, and 7) can function as a speaker system (i.e., a speaker phone) for electrical device 191 (FIGS. 1, 5, and 7) with the speakers, for example, being the car speaker system.

In the same or different embodiment, electrical device 191 (FIGS. 1, 5, and 7) can include a media player. Electrical accessory 1001 can wirelessly receive data signals from electrical device 191 (FIGS. 1, 5, and 7) using receiver 321 (FIG. 3) and transmit the data signals to receiving device 195 (e.g., a car radio and speaker system) via audio coupling 514 and/or transmitter 330.

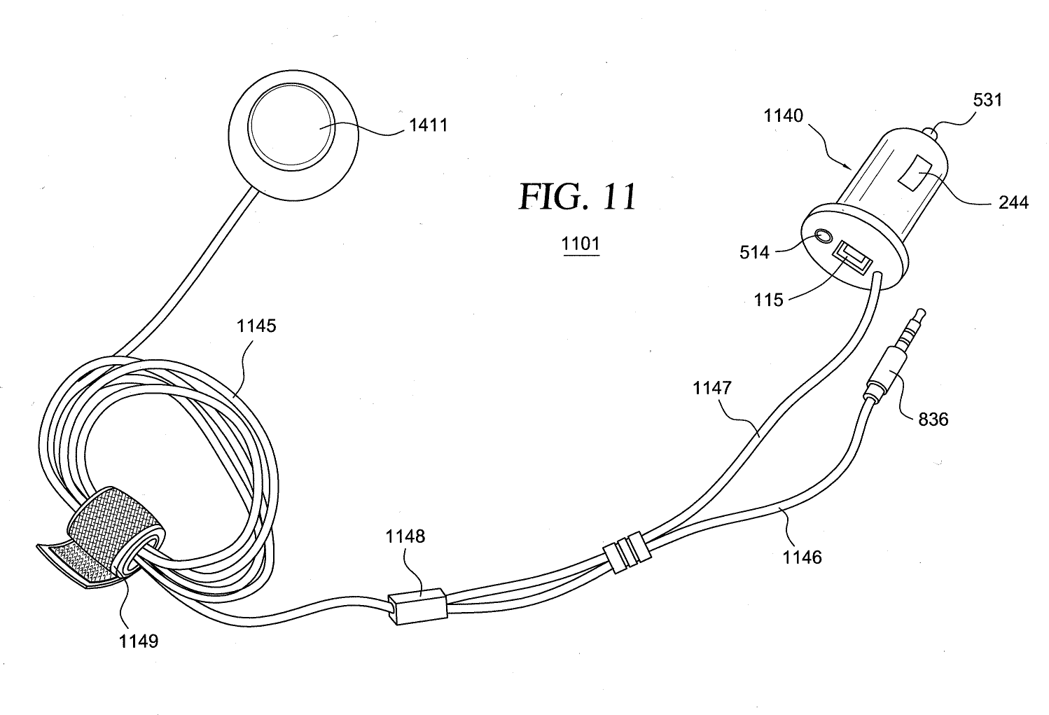

FIG. 11 illustrates an isometric view of electrical accessory 1101, according to a seventh embodiment. Electrical accessory 1101 is merely exemplary and is not limited to the embodiments presented herein. Electrical accessory 1101 can be employed in many different embodiments or examples not specifically depicted or described herein.

Referring to FIG. 11, an electrical device or electrical accessory 1101 can include: (a) a power acquisition unit (not shown) with an electrical coupling 531; (b) a user communications module (not shown); (c) at least one microphone (not shown); (d) a Bluetooth module (not shown); (e) an electrical coupling 115; (f) at least one audio coupling 514 and/or 836; and (g) electrical cords 1145, 1146, and 1147. In some examples, electrical accessory 1101 can also include a communications module with a radio frequency transmitter (not shown). In the same or different examples, audio coupling 836 can be configured to couple to an audio coupling on receiving device 195 (FIGS. 1, 5, and 7). In some examples, electrical accessory can function similarly or identical to at least one of electrical accessory 101, 501, 701, 801, 901, or 1001 of FIGS. 1, 5, 7, 8, 9, and 10, respectively.

In some examples, electrical accessory 1101 can further include a main housing 1140 and a peripheral housing 1141. At least a part of the electronics of electrical accessory 1101 can be located in each of main housing 1140 and peripheral housing 1141. For example, main housing can include two electrical boards (not shown). One electrical board can include at least part of the user communications module and the microphone. The second electrical board can include at least the Bluetooth module. Peripheral housing 1141 can include at least one electrical board that includes at least part of the power acquisition unit, audio coupling 514, and electrical coupling 115.

In various embodiments, electrical cord 1145 can split into two electrical cords 1146 and 1147 at splitter 1148. Peripheral housing 1141 can be mechanically and electrically coupled to main housing 1140 by electrical cords 1145 and 1147. Audio coupling 836 can be coupled to peripheral housing 1141 by electrical cords 1145 and 1146.

In some examples, electrical accessory 1101 can include a cord management feature 1149. In some examples, cord management feature 1149 can be Velcro® material configured to wrap around at least a part of electrical cords 1145, 1146, and 1147.

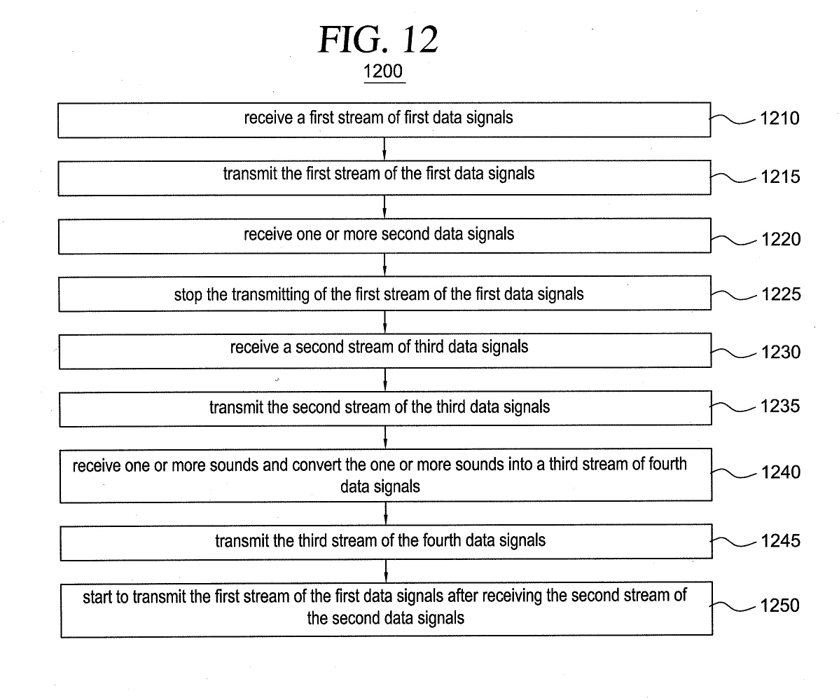

FIG. 12 illustrates an example of a method 1200 of using an electrical accessory, according to an embodiment. Method 1200 is merely exemplary, and is not limited to the specific embodiments or examples presented herein. Accordingly, method 1200 can be employed in many other sequences, embodiments, or examples not specifically depicted or described herein. In some embodiments, the activities of method 1200 described in the flow chart of FIG. 12 can be performed in the order presented. In other embodiments, the activities of the method 1200 described in the flow chart of FIG. 12 can be performed in any other suitable order. In still other embodiments, one or more of the activities described in method 1200 can be combined or omitted.

Method 1200 can begin with an activity 1210 of receiving a first stream of first data signals. In some examples, an electrical accessory can receive the first stream of the first data signals from a first electrical device via a first electrically coupling. In some embodiments, the electrical accessory can be mechanically and electrically coupled to first electrical device. For example, the electrical accessory receiving the first stream of the first data signals from a first electrical device via a first electrically coupling can be similar or identical to electrical accessory 101 receiving data signals from electrical device 190 via electrical coupling 111, as shown in FIG. 1. In another example, the electrical accessory receiving the first stream of the first data signals from a first electrical device via a first electrically coupling can be similar or identical to electrical accessory 501 (FIGS. 5 and 6) receiving data signals from electrical device 190 (FIG. 1) via audio interface 637 (FIG. 6). In some examples, electrical accessory can be similarly or identical to at least one of electrical accessory 101, 501, 701, 801, 901, 1001, or 1101 of FIGS. 1, 5, 7, 8, 9, 10, and 11, respectively.

Method 1200 can continue with an activity 1215 of transmitting the first stream of the first data signals. In some embodiments, an electrical accessory can transmit the first stream of the first data signals using a frequency modulated radio frequency transmitter to a receiving device. For example, the electrical accessory transmitting the first stream of the first data signals using a frequency modulated radio frequency transmitter to a receiving device can be similar or identical to electrical accessory 101, 501, 701, 801, 901, 1001, or 1101 of FIGS. 1, 5, 7, 8, 9, 10, and 11, respectively, transmitting data signals using transmitter 330 (FIG. 3) to a receiving device 195 (FIGS. 1, 5, and 7). In some examples, the first stream of first data signals can be music.

Next, method can include an activity 1220 of receiving one or more second data signals. In some embodiments, an electrical accessory can receive the one or more second data signals from a second electrical device using a Bluetooth receiver. For example, the electrical accessory receiving the one or more second data signals from a second electrical device using a Bluetooth receiver can be similar or identical to electrical accessory 101, 501, 701, 801, 901, 1001, or 1101 of FIGS. 1, 5, 7, 8, 9, 10, and 11, respectively, receiving data signals from electrical device 191 (FIGS. 1, 5, and 7) using a Bluetooth receiver 321 (FIG. 3). In some embodiments, the one or more second data signals can be an indication that the second electrical device is receiving a telephone call (e.g., the ringing of the telephone).

Method 1200 in FIG. 12 can further include an activity 1225 of stopping the transmitting of the first stream of the first data signals. In some examples, a controller in the electrical accessory can instruct the first electrical device to stop providing the first stream of first data signals and the frequency modulated radio frequency transmitter can stop transmitting the first stream of first data signals. For example, the controller can be similar or identical to controller 311 of FIG. 3 or controller 1011 of FIG. 10. In other examples, stopping the transmitting of the first stream of the first data signals can occur after or in response to the receiving of the second stream of third data signals in activity 1230 or the transmitting of the second stream of third data signals in activity 1235. In still other embodiments, activity 1225 can occur after, or in response to, a further signal from electrical device 191 (FIGS. 1, 5, and 7).

Method 1200 of FIG. 12 continues with an activity 1230 of receiving a second stream of third data signals. In some examples, the electrical accessory can receive the second stream of the third data signals from the second electrical device using the Bluetooth receiver. In some embodiments, receiving the second stream of third data signals can be similar or identical to receiving the one or more second data signals in activity 1220. In various examples, the second stream of third data signals can be the incoming audio for a telephone call.

Method 1200 of FIG. 12 further includes an activity 1235 of transmitting the second stream of the third data signals. In some examples, the electrical accessory can transmit the second stream of the third data signals using the frequency modulated radio frequency transmitter to the first external speaker system. In some examples, transmitting the second stream of the third data signals can be similar or identical to transmitting the first stream of the first data signals in activity 1215.

Next, method 1200 of FIG. 12 includes an activity 1240 of receiving one or more sounds and converting the one or more sounds into a third stream of fourth data signals. In some examples, a microphone in the electrical accessory can receive the one or more sounds and convert the one or more sounds into a third stream of fourth data signals. For example, the microphone can be similar or identical to microphone 117 or 518 of FIGS. 1 and 5, respectively. In other examples, the one or more sounds can be received using an external microphone coupled to an audio coupling in the electrical accessory.

Method 1200 of FIG. 12 continues with an activity 1245 of transmitting the third stream of fourth data signals. In some examples, the electrical accessory can transmit the third stream of fourth data signals to the second electrical device using a Bluetooth transmitter. For example, the electrical accessory transmitting the third stream of fourth data signals to the second electrical device using a Bluetooth transmitter can be similar or identical to the electrical accessory 101, 501, 701, 801, 901, 1001, or 1101 of FIGS. 1, 5, 7, 8, 9, 10, and 11, respectively, respectively, transmitting data signals to electrical device 191 (FIGS. 1, 5, and 7) using a Bluetooth transmitter 320 (FIG. 3). In some embodiments, the third stream of fourth data signals can be the outgoing audio (e.g., the voice of the user of the electrical accessory) for a telephone call.

Method 1200 of FIG. 12 further includes an activity 1250 of starting to transmit the first stream of the first data signals after receiving the second stream of the second data signals. In some examples, the electrical accessory can transmit the third stream of fourth data signals using the frequency modulated radio frequency transmitter to the first external speaker system. For example, the electrical accessory transmitting the first stream of the first data signals using a frequency modulated radio frequency transmitter to a receiving device can be similar or identical to electrical accessory 101, 501, 701, 801, or 1001 of FIGS. 1, 5, 7, 8, and 10, respectively transmitting data signals using transmitter 330 (FIG. 3) to a receiving device 195 (FIGS. 1, 5, and 7). In some examples, transmitting the third stream of fourth data signals can be similar or identical to transmitting the first stream of the first data signals of activity 1215. In some examples, the second stream of third data signals will end after the telephone call is complete. When the call is complete, the electrical accessory can instruct the first electrical device to start or unpause the music it was previously playing.

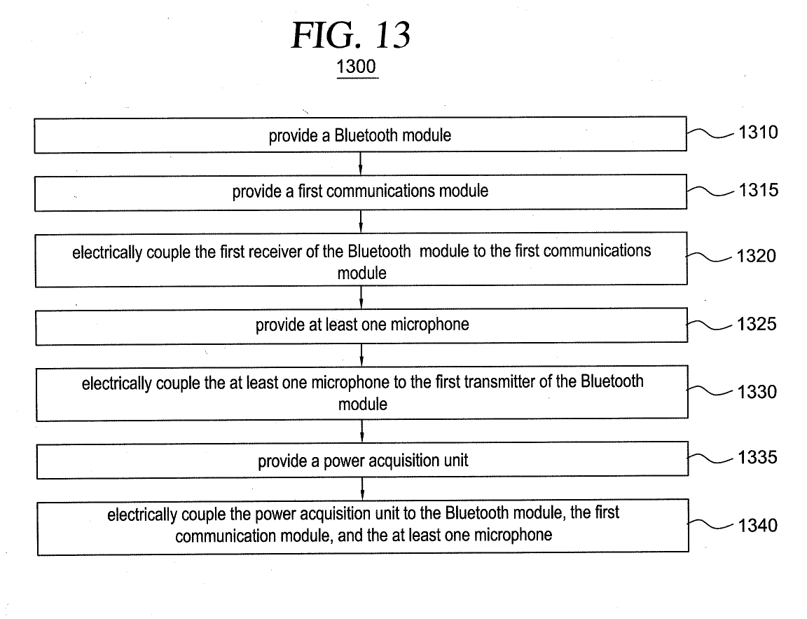

FIG. 13 illustrates an example of a method 1300 of providing an electrical accessory, according to an embodiment. Method 1300 is merely exemplary, and is not limited to the specific embodiments or examples presented herein. Accordingly, method 1300 can be employed in many other sequences, embodiments, or examples not specifically depicted or described herein. In some embodiments, the activities of the method 1300 described in the flow chart of FIG. 13 can be performed in the order presented. In other embodiments, the activities of the method 1300 described in the flow chart of FIG. 13 can be performed in any other suitable order. In still other embodiments, one or more of the activities described in method 1300 can be combined or omitted.

Method 1300 can begin with an activity 1310 of providing a Bluetooth module. In some examples, the Bluetooth module can include a first receiver and a first transmitter. In some examples, the first receiver can be configured to transmit data signals using a Bluetooth wireless protocol. The first transmitter can also be configured to transmit data signals using a Bluetooth wireless protocol. For example, the first receiver and the first transmitter can be similar or identical to receiver 321 and transmitter 320, respectively, of FIG. 3. In some examples, the Bluetooth module can be similar or identical to Bluetooth module 325 of FIG. 3.

Method 1300 in FIG. 13 continues with an activity 1315 of providing a first communications module. In some examples, a first communications module can include a second transmitter configured to transmit data signals over the set of radio frequencies. For example, the second transmitter can be similar or identical to transmitter 330 of FIG. 2. In some examples, the first communications module can be similar or identical to communications module 335 or 635 of FIGS. 3 and 6, respectively.

In other examples, the first communications module can include an audio interface configured to couple to an audio interface of a receiving device. For example, the audio interface can be similar or identical to audio interface 337, 637, or 837 of FIGS. 3, 6, and 8, respectively.

Method 1300 of FIG. 13 further includes an activity 1320 of electrically coupling the first receiver to the first communications module. In some examples, the first receiver can be electrically coupled to the first communications module similar or identical to the electrical coupling of Bluetooth module 325 to transmitter 330, as illustrated in FIG. 3.

Method 1300 of FIG. 13 further includes an activity 1325 of providing at least one microphone. The at least one microphone can receive sounds and convert the sounds into data signals. In some examples, the at least one microphone can be similar or identical to microphone 117 or 518 of FIGS. 1 and 5, respectively.

Method 1300 in FIG. 13 continues with an activity 1330 of electrically coupling the at least one microphone to the first transmitter. In some examples, the at least one microphone can be electrically coupled to the first transmitter similar or identical to the electrical coupling of microphone 117 to Bluetooth module 325, as illustrated in FIG. 3 and/or the electrical coupling of microphone 518 to Bluetooth module 325, as illustrated in FIG. 6.

Method 1300 includes an activity 1335 of providing a power acquisition unit. The power acquisition unit can be configured to receive electrical power from an external power source. As an example, the power acquisition unit can be similar or identical to power acquisition unit 113 of FIG. 1. In some examples, the external power source can be a vehicle cigarette lighter, and the power acquisition unit can include a vehicle cigarette lighter adapter.

Next, method 1300 of FIG. 13 includes an activity 1340 of electrically coupling the power acquisition unit to the Bluetooth module, the first communication module, and the at least one microphone. In some examples, the coupling of the power acquisition unit to the Bluetooth module, the first communication module, and the at least one microphone can be similar or identical to the coupling of power acquisition unit 113 to Bluetooth module 325, transmitter 330, and microphone 117, as shown in FIG. 3. In some examples, the coupling of the power acquisition unit to the Bluetooth module, the first communication module, and the at least one microphone can be similar or identical to the coupling of power acquisition unit 612 to Bluetooth module 325, audio interface 637, and microphone 518, as shown in FIG. 6.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that receiving the second signals in activity 1220 of FIG. 12 can be combined with, or considered part of, in some example, the receiving of the second stream of third data signals in activity 1230 of FIG. 12, and the stopping of the transmission of the first stream of first data signals in activity 1225 of FIG. 12 can be in response to the receiving and/or transmitting of the combined second signals and second stream of third data signals and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. An electrical accessory configured to transmit one or more first data signals to a receiving device, the electrical accessory comprising:
a first electrical interface configured to mechanically and electrically couple to a first connector of a first electrical device, the first electrical interface further configured to receive a first part of the one or more first data signals from the first electrical device;
a first transmitter configured to transmit one or more second data signals to a second electrical device;
a first receiver configured to receive a second part of the one or more first data signals from the second electrical device;
a second transmitter electrically coupled to the first electrical interface and the first receiver, the second transmitter configured to transmit the one or more first data signals to the receiving device;
a first microphone electrically coupled to the first transmitter and configured to receive sounds and convert the sounds into the one or more second data signals; and
a controller electrically coupled to the first transmitter, the first receiver, the second transmitter, and the first microphone,
wherein:
the controller is configured such that the controller instructs the first electrical device to stop providing the first part of the one or more first data signals, before or when the first receiver receives the second part of the one or more first data signals from the second electrical device.

2. The electrical accessory of claim 1, wherein:
the first receiver is configured to receive one or more third data signals before the first receiver receives the second part of the one or more first data signals from the second electrical device; and
the one or more third data signals are an indication that the second device will begin to transmit of the second part of the one or more first data signals.

3. The electrical accessory of claim 1, wherein:
the first receiver is configured to receive one or more third data signals before the first receiver receives the second part of the one or more first data signals from the second electrical device; and
the one or more third data signals are an indication that the second electrical device is receiving a telephone call.

4. The electrical accessory of claim 1, further comprising:
a second electrical interface configured to electrically and mechanically couple to the receiving device to provide the one or more first data signals to the receiving device,
wherein:
the controller is configured such that the controller instructs the second transmitter to stop transmitting the one or more first data signals to the receiving device when the second electrical interface is electrically coupled to the first receiving device.

5. The electrical accessory of claim 1, further comprising:
one or more buttons,
wherein:
a first one of the one or more buttons is configured such that, when or after a user activates the first one of the one or more buttons, the controller instructs the second transmitter to begin transmitting the second part of the one or more first data signals to the receiving device.

6. The electrical accessory of claim 1, wherein:
the first part of the one or more first data signals comprises music.

7. The electrical accessory of claim 1, wherein:
the second part of the one or more first data signals comprises voice signals from a telephone call.

8. The electrical accessory of claim 1, further comprising:
electrical device controls,
wherein:
the electrical device controls comprises a single button;
the single button is configured to begin and end a telephone call on the second electrical device; and
the single button is further configured to signal to the first electrical device to play, pause, fast forward, and rewind audio being played on the first electrical device.

9. The electrical accessory of claim 1, wherein:
the first receiver is a Bluetooth receiver; and
the first transmitter is a Bluetooth transmitter.

10. The electrical accessory of claim 1, wherein:
the second transmitter is a frequency modulated radio transmitter.

11. The electrical accessory of claim 1, further comprising:
a first transceiver comprising the first receiver and the first transmitter.

12. The electrical accessory of claim 1, further comprising:
a power acquisition unit configured to receive electrical power from an external power source.

13. The electrical accessory of claim 12, further comprising:
a holder configured to hold the first electrical device; and
a semi-rigid elongated portion configured to allow a position of the holder to be semi-permanently adjusted relative to a position of the power acquisition unit,
wherein:
the semi-rigid elongated portion is an antenna and is further configured to radiate the one or more first data signals.

14. The electrical accessory of claim 1, wherein:
the first electrical interface comprises a thirty-pin connector.

15. An apparatus configured to couple to a first media device, the apparatus comprising:
a Bluetooth module configured to transmit first data to the first media device and receive second data from the first media device;
at least one first control configured to at least partially operate the first media device;
a communications module electrically coupled to the Bluetooth module, the communications module is configured to transmit the second data received from the first media device to an external speaker system over at least one frequency modulated radio frequency;
a microphone electrically coupled to the Bluetooth module and configured to provide the first data to the Bluetooth module; and
a power acquisition unit configured to couple to an external electrical power source and configured to provide electrical power to at least the Bluetooth module, the microphone, the communications module, and the at least one first control.

16. The apparatus of claim 15, further comprising:
a first electrical coupling electrically coupled to the communications module and configured to couple to a second media device and receive third data from the second media device; and
the communications module is further configured to transmit the third data to the external speaker system over the frequency modulated radio frequency.

17. The apparatus of claim 16, wherein:
the communications module is further configured to transmit the third data to the external speaker system until the communications module is instructed to begin transmitting the second data to the external speaker system.

18. The apparatus of claim 15, further comprising:
a first housing at least partially enclosing the Bluetooth module, the communications module, and the power acquisition unit.

19. The apparatus of claim 18, further comprising:
a second housing,
wherein:
the microphone and the at least one first control are located at the second housing.

20. The apparatus of claim 15, wherein:
the communications module comprises:
a frequency modulated radio frequency transmitter electrically coupled to the Bluetooth module, the frequency modulated radio frequency transmitter is configured to transmit the second data to the external speaker system.

21. The apparatus of claim 15, wherein:
the communications module comprises:
an electrical coupling electrically coupled to the Bluetooth module and configured to electrically and mechanically couple to the external speaker system, the electrical coupling is further configured to transmit the second data to the external speaker system.

22. The apparatus of claim 15, further comprising:
a display configured to display information related to the Bluetooth module.

23. A method of using an electrical accessory, the method comprising:
receiving a first stream of first data signals;
transmitting the first stream of the first data signals;
receiving one or more second data signals;
stopping the transmitting of the first stream of the first data signals;
receiving a second stream of third data signals;
transmitting the second stream of the third data signals; and
starting to transmit the first stream of the first data signals after receiving the second stream of the second data signals.

24. The method of claim 23, wherein:
receiving the first stream of the first data signals comprises:
receiving the first stream of the first data signals from a first electrical device;
receiving the one or more second data signals comprises:
receiving the one or more second data signals from a second electrical device; and
receiving the second stream of the third data signals comprises:
receiving the second stream of the third data signals from the second electrical device.

25. The method of claim 23, further comprising:
receiving one or more sounds;
converting the one or more sounds into a third stream of fourth data signals; and
transmitting the third stream of the fourth data signals.

26. The method of claim 23, wherein:
transmitting the first stream of the first data signals comprises:
transmitting the first stream of the first data signals to a first external speaker system; and
transmitting the second stream of the third data signals comprises:
transmitting the second stream of the third data signals to the first external speaker system.

27. The method of claim 23, wherein:
receiving the first stream of the first data signals comprises:
receiving the first stream of the first data signals using a first electrically coupling;
transmitting the first stream of the first data signals comprises:
transmitting the first stream of the first data signals using a frequency modulated radio frequency transmitter;
receiving the one or more second data signals comprises:
receiving the one or more second data signals using a Bluetooth receiver;
receiving the second stream of the third data signals comprises:
receiving the second stream of the third data signals using the Bluetooth receiver; and
transmitting the second stream of the third data signals comprises:
transmitting the second stream of the third data signals using the frequency modulated radio frequency transmitter.
